(19) United States
(12) Patent Application Publication
(10) Pub. No.: US 2020/0050778 A1
(43) Pub. Date: Feb. 13, 2020

(54) COMPUTER IMPLEMENTED METHOD FOR OPERATING A DATA STORAGE DEVICE

(71) Applicant: INNOTECH21 GMBH, Oettingen in Bayern (DE)

(72) Inventors: Ulrich LECHNER, Oettingen in Bayern (DE); Sebastian LECHNER, Oettingen in Bayern (DE)

(21) Appl. No.: 16/451,382

(22) Filed: Jun. 25, 2019

(30) Foreign Application Priority Data
Jun. 26, 2018 (EP) 18179762.2

(51) Int. Cl. G06F 21/62; G06F 16/11; G06F 11/14

(52) U.S. Cl. CPC G06F 21/6209; G06F 2201/80; G06F 11/1451; G06F 16/122

(57) ABSTRACT

In order to improve a computer-implemented method for operating a data storage device, including an access management unit for a file system by which, in the event of an access request, generated by a process in a data processing device and transmitted to the data storage device, for a file of the file system, this file is made available for file access, wherein the improvement is such that this computer-implemented method is protected from malware, in particular ransomware, it is proposed that the access management unit should include a file securing unit by which, in the event of an access request for the file that is forwarded to this file securing unit, a file securing routine is started, that the access request should be blocked until a backup copy of the file has been created and stored, that the access request should then be forwarded to an access layer for the file system, and that access should be carried out by the access layer.

This patent application claims the benefit of European application No. 18 179 762.2, filed Jun. 26, 2018, which is incorporated herein by reference in its entirety and for all purposes.

The invention relates to a computer-implemented method for operating a data storage device, including an access management unit for a file system by which, in the event of an access request, generated by a process in a data processing device and transmitted to the data storage device, for a file of the file system, this file is made available for file access.

In methods of this kind, it is problematic that malware, in particular ransomware, may trigger access requests and thus encrypt files or damage them in another way.

The object of the invention is thus to improve a computer-implemented method for operating a data storage device having the above-mentioned features such that it is protected from malware, in particular ransomware.

This object is achieved according to the invention with a computer-implemented method for operating a data storage device in that the access management unit includes a file securing unit by which, in the event of an access request for the file that is forwarded to this file securing unit, a file securing routine is started, in that the access request is blocked until a backup copy of the file has been created and stored, in that the access request is then forwarded to an access layer for the file system, and in that access is carried out by the access layer.

The advantage of the solution according to the invention can be seen in the fact that during the file securing routine the file securing unit on the one hand creates a backup copy of the file to be accessed and on the other blocks access to the file until the backup copy has been created and stored, with the result that even if file access is started by malware, in particular ransomware, the encryption of the file or other damage to the file does not result in the loss of information in the file but rather the backup copy still remains present, and once the process caused by the malware or ransomware has been removed this backup file can be located again and is available.

Here, it is particularly advantageous if, during the file securing routine, the backup copy of the file is stored in a protected data memory.

A protected data memory of this kind may for example be a protected region of the same data memory on which the file system is stored, but it is also conceivable to provide a separate, additional data memory for storing the backup copy.

In the context of the explanation of the solution according to the invention so far, more detailed statements have not been made as regards the further construction of the access management unit.

Thus, an advantageous solution provides for a fingerprint determining unit, which, for the respective access request, determines a fingerprint that identifies the access request and forwards the access request together with the fingerprint.

By creating a fingerprint for identification of the access request, it is ensured that it is possible later to reproduce which access request was the basis for encrypting or damaging the file that was accessed.

Here, determining the fingerprint may be performed in a more or less complex manner.

Simple ways of determining a fingerprint are based for example on one or more items of information, such as a process ID and/or a checksum and/or information on additional programs used in the process.

Here, the degree of uniqueness of the fingerprint increases with the degree of complexity of the structure and composition of the fingerprint.

A particularly preferred solution provides for the fingerprint determining unit to determine a fingerprint on the basis of the process information in the access request, and on the basis of a unique identification criterion determined in relation to the process.

Thus, a fingerprint of this kind has a very high degree of uniqueness of the fingerprint.

The most diverse possibilities are conceivable for carrying out the fingerprint determination.

Thus, an advantageous solution provides for the fingerprint determination to be performed by the access management unit.

This is in particular the case if the access request is made in a data processing device that is directly connected to the data storage device.

Another advantageous solution provides for the fingerprint determination to be performed in the data storage device of upstream clients that generate the respective access request.

This solution is provided in particular if the data storage device communicates with the clients over a LAN system.

In order, in this case, to link the fingerprint and with the access request, it is preferably provided here for the respective fingerprint to be directly associated with the respective access request and in particular to be transmitted with it.

Another solution, in which direct association is unfavorable or impossible, provides for the respective fingerprint to be associated with the access request by means of an identifier, with the result that the fingerprint and the access request can be transmitted separately but the access management unit for example is then able to make the association between the fingerprint and the access request.

Moreover, a further advantageous solution of the method according to the invention provides for the access management unit to include at least one access filter, which checks an access request for at least one filter criterion and, in the event of this filter criterion being met, forwards the access request directly to the access layer, bypassing the file securing unit.

An access filter of this kind has the great advantage that, in this way, it is not necessary to create a backup copy of a file every time there is an access request, but rather a multiplicity of access requests that meet the filter criterion can be forwarded directly to the access layer.

In particular, it is provided here for the access filter to include a first filter stage, which checks whether an access request relates to an existing file or a file to be newly generated, and which, in the case of a file to be newly generated, forwards the access request directly to the access layer, bypassing the file securing unit.

Another advantageous solution provides for the access filter to have a second filter stage, which checks whether an access request includes a write request or not, and which, in the event that there is no write request, forwards the access request directly to the access layer, bypassing the file securing unit.

A further advantageous solution provides for the access filter to have a third filter stage, which compares the fingerprint associated with the access request with a stored whitelist of fingerprints that are evaluated as safe, and which, in the event that the fingerprint of the access request is identical to a fingerprint in the whitelist, forwards the access request directly to the access layer, bypassing the file securing unit.

Each of these three filter stages thus enables the number of backup copies of files to be reduced.

A further advantageous solution provides for the access management unit to extract the fingerprint from the access request supplied to the file securing unit and to store it in a gray list of a process check.

Such extraction of the fingerprint and storage thereof in a gray list has the advantage that it is possible subsequently to allocate the fingerprint to a whitelist.

Thus, an advantageous solution provides for the process check to supply the gray list to a check procedure and for the check procedure to transfer the respective fingerprint in the gray list either to the whitelist of the third filter stage or to another location.

The other location may be a spam area or, however, it may be the case that the fingerprint is discarded as an unsafe fingerprint.

A further advantageous solution provides, during the check procedure, for the process check to transfer the respective fingerprint in the gray list either to the whitelist of the third filter stage or to a blacklist.

Here, a blacklist has the advantage that it makes it possible to trace the fact that the fingerprint belongs with a process that was triggered by malware, in particular ransomware.

As regards carrying out the check, it is possible for the check procedure to be carried out by a user.

Here, such a user may determine after a certain period has elapsed—for example after a few days or a few weeks—that the process responsible for the access request was not triggered by malware or ransomware, with the result that in this case the user can include the fingerprint in the whitelist.

However, it is also possible to automate this in that if, after a certain period has elapsed—for example after days or weeks—there has been no damage to or encryption of a file, the fingerprint is transferred to the whitelist.

The most diverse possibilities are conceivable for storing the fingerprint.

Thus, an advantageous solution provides for the file securing unit to associate the fingerprint with the backup copy.

Another advantageous solution provides, when the backup copy is created, for the file securing unit to associate the fingerprint with the file that is accessed.

However, it is also possible, when the backup copy is created, for the fingerprint to be stored at another location but to be associated with the file that is accessed or with the backup copy by labeling a link.

Moreover, for the purpose of protecting the file system, it is preferably provided for access to the file system by the access layer to take place by way of a block position transformation stage.

A block position transformation stage has the effect that some of the blocks of a file system header of the file system are stored in different block positions from the usual block positions—namely for example the first block positions of the file system—and, when access to the file system is carried out, they are mirrored in the originally provided block positions without being stored there.

The advantage of a block position transformation stage of this kind can be seen in the fact that if the access layer is switched off as a result of a malware attack, or indeed only the block position transformation stage is switched off by a malware attack, the file system is no longer accessible, since, as a result of shifting some of the blocks of the file system header, the files in the file system can no longer be recognized without the active block position transformation stage.

In addition or as alternative to providing a block position transformation stage, a further advantageous variant of the method according to the invention provides for the file system to be an encrypted file system and for access by the access layer to take place by way of an encryption stage.

Such an encryption stage has the advantage that if the access layer is switched off the encryption stage is likewise no longer activated and so an access request can no longer recognize and locate the respective file.

Moreover, the invention relates to a data processing system, including one or more processors that are configured to carry out the method as claimed in one of claims 1 to 21.

Further, the invention includes a computer program product, including commands that, when the program is executed by a computer, cause it to carry out the method as claimed in one of claims 1 to 21.

Finally, the invention relates to a computer-readable storage medium, including commands that, on execution by a computer, cause it to carry out the method as claimed in claims 1 to 21.

The description above of inventive solutions thus includes in particular the different combinations of features that are defined by the sequentially numbered embodiments below:

1. A computer-implemented method for operating a data storage device (14), including an access management unit (26) for a file system (16) by which, in the event of an access request (24) generated by a process (22) in a data processing device (12) and transmitted to the data storage device (14), for a file (18) of the file system (16), this file (18Z) is made available for file access,

characterized in that the access management unit (26) includes a file securing unit (34) by which, in the event of an access request (24) for the file (18Z) that is forwarded to this file securing unit (34), a file securing routine (36) is started, in that the access request (24) is blocked until a backup copy (18S) of the file (18Z) has been created and stored, in that the access request (24) is then forwarded to an access layer (32) for the file system (16), and in that access is carried out by the access layer (32).

2. A method according to embodiment 1, characterized in that, during the file securing routine, the backup copy (18S) of the file (18Z) is stored in a protected data memory.

3. A method according to embodiment 1 or 2, characterized in that a fingerprint determining unit (46, 114) is provided, which, for the respective access request, determines a fingerprint (66) that identifies the access request and forwards the access request (24) together with the fingerprint (66).

4. A method according to embodiment 3, characterized in that the fingerprint determining unit determines the fingerprint (66) on the basis of one or more items of information, such as process IDs and/or checksums and/or information on additional programs used in the process.

5. A method according to embodiment 4, characterized in that the fingerprint determining unit (46) determines a fingerprint (66) on the basis of the process information (62) in the access request (24), and on the basis of a unique identification criterion determined in relation to the process (22).

6. A method according to one of embodiments 3 to 5, characterized in that the fingerprint determination (46) is performed by the access management unit (26).

7. A method according to one of embodiments 3 to 6, characterized in that the fingerprint determination (114) is performed in the data storage device (14) of upstream clients (104, 106, 108) that generate the respective access request (24).

8. A method according to embodiment 7, characterized in that the respective fingerprint (66) is directly associated with the respective access request.

9. A method according to embodiment 7 or 8, characterized in that the respective fingerprint (66) is associated with the access request (24) by means of an identifier (122).

10. A method according to one of the preceding embodiments, characterized in that the access management unit (26) includes at least one access filter (28), which checks an access request (24) for at least one filter criterion and, in the event of this filter criterion being met, forwards the access request (24) directly to the access layer (32), bypassing the file securing unit (34).

11. A method according to embodiment 10, characterized in that the access filter (28) includes a first filter stage (42), which checks whether an access request (22) relates to an existing file (18) or a file (18N) to be newly generated, and which, in the case of a file (18N) to be newly generated, forwards the access request (24) directly to the access layer (32), bypassing the file securing unit (34).

12. A method according to embodiment 10 or 11, characterized in that the access filter (28) has a second filter stage (44), which checks whether an access request (24) includes a write request or not, and which, in the event that there is no write request, forwards the access request (24) directly to the access layer (32), bypassing the file securing unit (34).

13. A method according to one of embodiments 10 to 12, characterized in that the access filter has a third filter stage (48), which compares the fingerprint (66) associated with the access request with a stored whitelist (56) of fingerprints that are evaluated as safe, and which, in the event that the fingerprint (66) of the access request is identical to a fingerprint in the whitelist (56), forwards the access request directly to the access layer (32), bypassing the file securing unit (34).

14. A method according to one of the preceding embodiments, characterized in that the access management unit (26) extracts the fingerprint (66) from the access request (24) supplied to the file securing unit (34) and stores it in a gray list (74) of a process check (82).

15. A method according to embodiment 14, characterized in that the process check (82) supplies the gray list (74) to a check procedure (84), and in that the check procedure (84) transfers the respective fingerprint (66) in the gray list (74) either to the whitelist (56) of the third filter stage (48) or to another location.

16. A method according to embodiment 15, characterized in that, during the check procedure, the process check transfers the respective fingerprint (66) in the gray list (74) either to the whitelist (56) of the third filter stage (48) or to a blacklist (86).

17. A method according to embodiment 15 or 16, characterized in that the check procedure (84) is carried out by a user or automatically.

18. A method according to one of the preceding embodiments, characterized in that the file securing unit (34) associates the fingerprint (66) with the backup copy (18S).

19. A method according to one of the preceding embodiments, characterized in that, when the backup copy (18S) is created, the file securing unit (34) associates the fingerprint (66) with the file (18Z) that is accessed.

20. A method according to one of the preceding embodiments, characterized in that access to the file system (18) by the access layer (32) takes place by way of a block position transformation stage (132).

21. A method according to one of the preceding embodiments, characterized in that the file system (16′) is an encrypted file system (16′), and in that access by the access layer (32) takes place by way of an encryption stage (142).

22. A data processing system, including one or more processors that are configured to carry out the method according to one of embodiments 1 to 21.

23. A computer program product, including commands that, when the program is executed by a computer, cause it to carry out the method according to one of embodiments 1 to 21.

24. A computer-readable storage medium, including commands that, on execution by a computer, cause it to carry out the method according to embodiments 1 to 21.

Further features and advantages of the invention form the subject matter of the description below and the illustration in the drawings of some embodiments of a computer-implemented method according to the invention, a data processing system, a computer program product, and a computer-readable storage medium.

In the drawings:

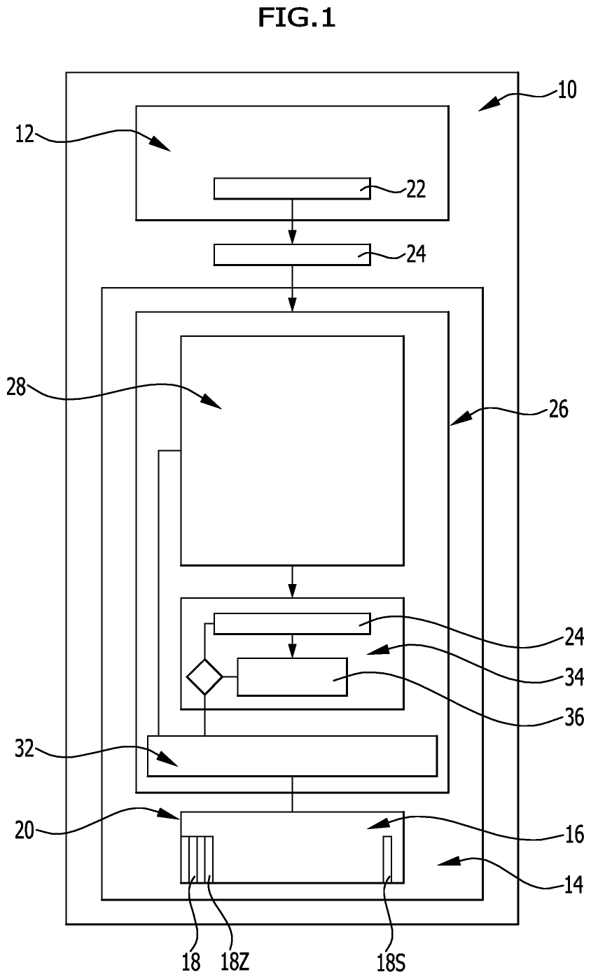

FIG. 1 shows a schematic illustration of a first exemplary embodiment of a data processing system according to the invention;

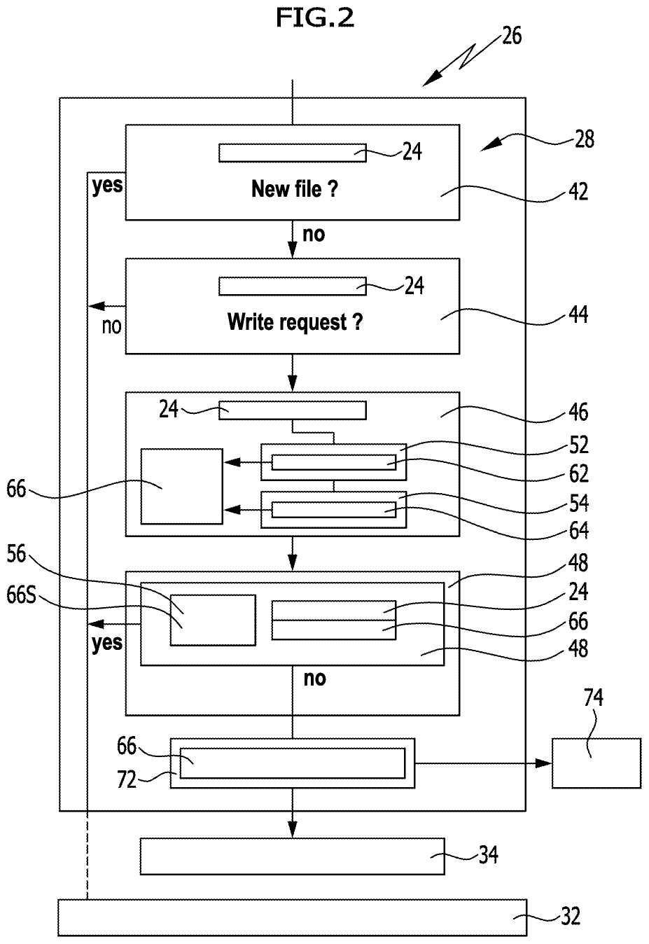

FIG. 2 shows an enlarged schematic illustration of the steps in carrying out access management;

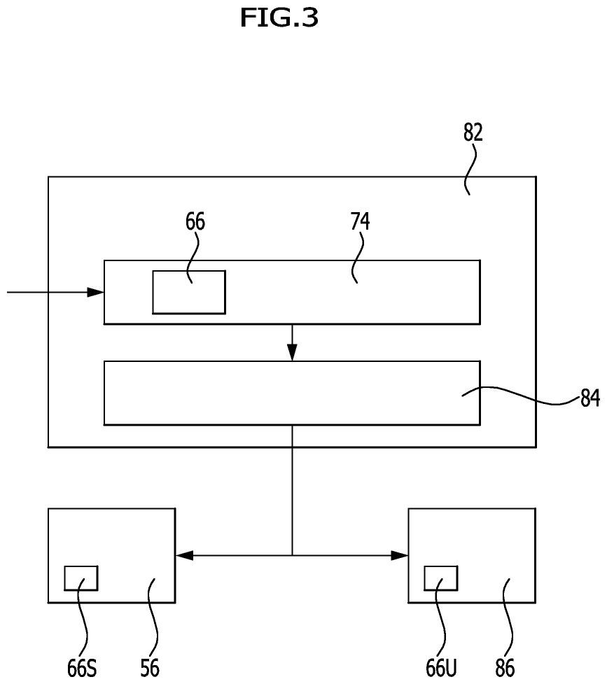

FIG. 3 shows a schematic illustration of the steps in an exemplary embodiment in the context of a process check of a gray list;

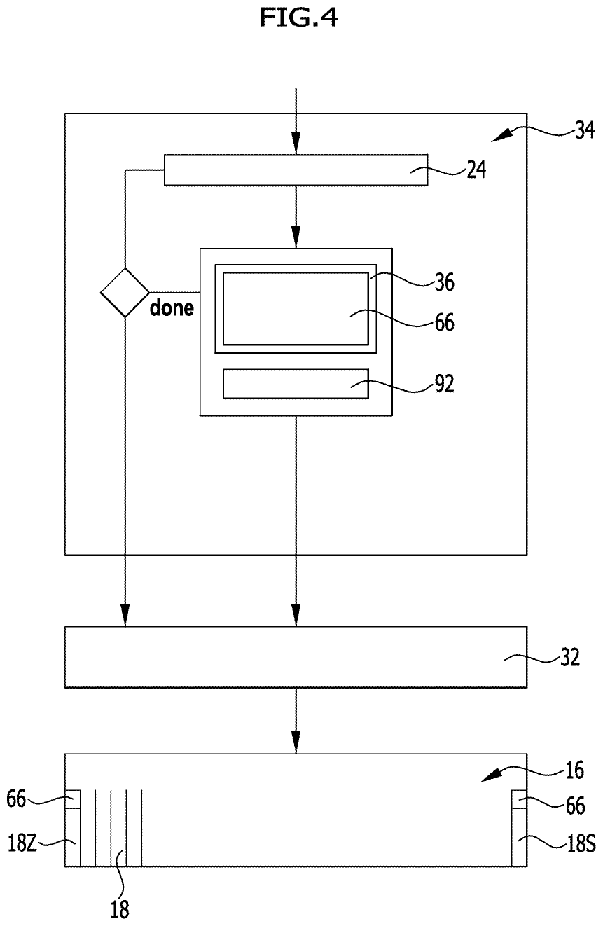

FIG. 4 shows a schematic illustration of the steps in the file securing;

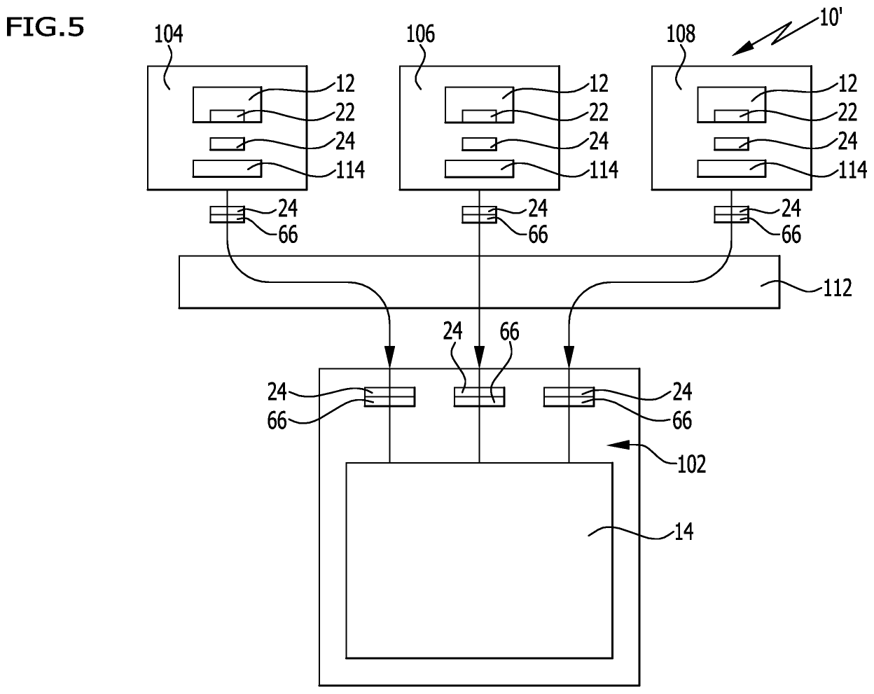

FIG. 5 shows a schematic illustration of a second exemplary embodiment of a data processing system according to the invention;

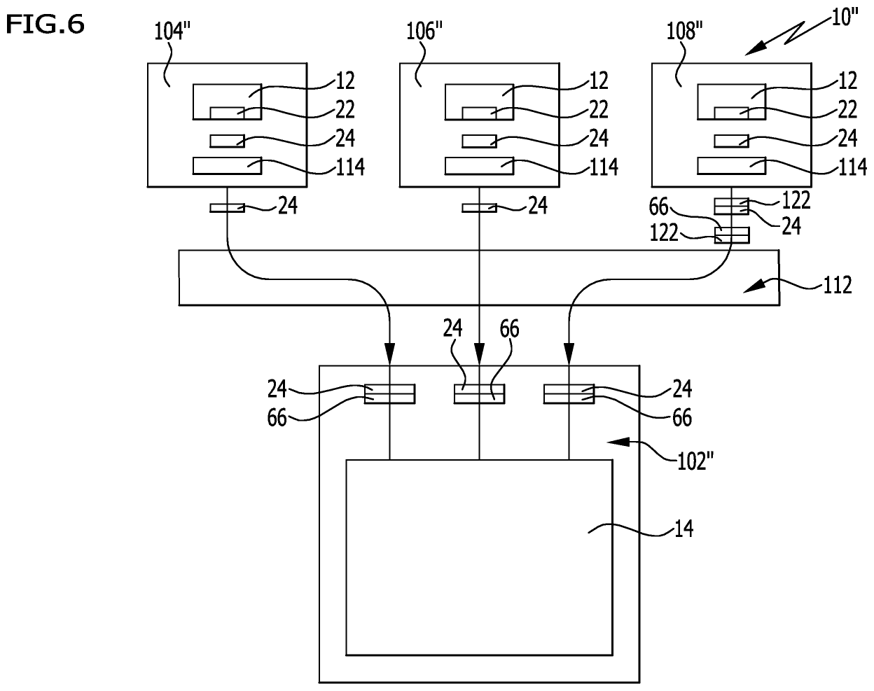

FIG. 6 shows a schematic illustration of a third exemplary embodiment of a data processing system according to the invention;

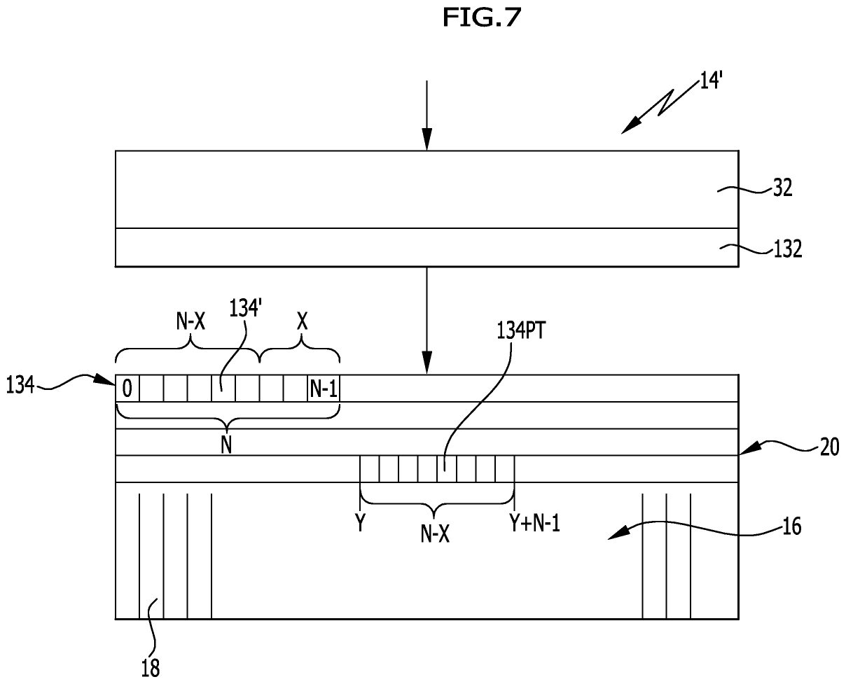

FIG. 7 shows a schematic illustration of a second exemplary embodiment of a data storage device according to the invention, and

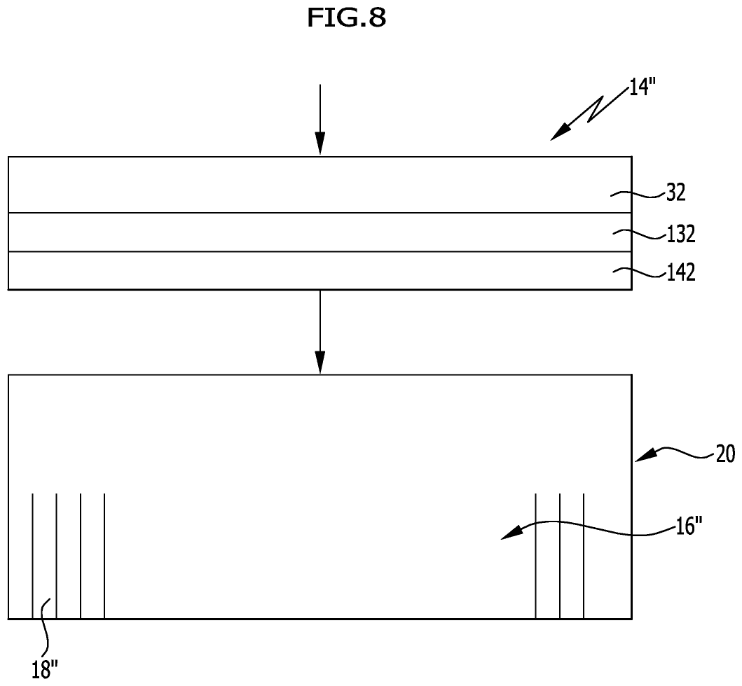

FIG. 8 shows a schematic illustration of a third exemplary embodiment of a data storage device according to the invention.

One exemplary embodiment of a data processing system 10 according to the invention includes, as illustrated in FIG. 1, a data processing device 12 and a data storage device 14, which cooperates with the data processing device 12 and in which there is stored a file system 16 that includes a multiplicity of individual files 18 stored in a physical data memory 20.

When a process 22 that is running in the data processing device 12, for example on the basis of a Word or Excel program, needs access to a particular file 18Z of the files 18 in the file system 16, it generates an access request 24, which is transmitted to the data storage device 14 by the data processing device 12.

Provided in the data storage device 14 is an access management unit, which is designated 26 as a whole and which, in the exemplary embodiment illustrated, includes an access filter 28 that checks the access requests 24 for at least one secure filter criterion and, in the event that this filter criterion is met, transmits the access request 24 directly to an access layer 32, which carries out access to the file system 16.

Further, the access management unit 26 includes a file securing unit 34, which the access request 24 is transmitted in the case of all access requests 24 that do not meet the at least one secure filter criterion of the access filter 28.

The access request 24 is initially held up by the file securing unit 34 until a file securing routine 36 of the file securing unit 34 has created a backup copy 18S of the respective file 18Z for which the access request 24 is provided and has stored it in a secure area of the file system 16, for example a so-called WORM area, or indeed on a different file system. Only once the backup copy 18S of the file 18Z has been securely stored is the access request 24 forwarded to the access layer 32, which then carries out access of the respective file 18Z in the file system 16.

The access filter 28 may take the most diverse forms, and operate with the most diverse secure filter criteria.

An exemplary embodiment of the access filter 28, illustrated in FIG. 2, includes a first filter stage 42, which checks whether an incoming access request 24 relates to an existing file 18 or a file 18N that is to be newly generated, and in the case of a file to be newly generated the access request 24 is forwarded directly to the access layer 32.

In the event that the access request is for an existing file 18, the first filter unit 42 forwards the access request 24 to a second filter stage 44, which checks whether the access request 24 includes a write request.

If there is no write request, the second filter stage 44 forwards the access request 24 directly to the access layer 32.

If there is a write request, the second filter stage 44 forwards the access request 24 to a fingerprint determining unit 46, which determines for the respective access request 24 data identifying it, wherein this data represents a “fingerprint” of the access request and a way of uniquely identifying the access request 24.

In principle, the most diverse information, such as a process ID and/or a checksum and/or information on additional programs used in the process 22, may be used for such a fingerprint, wherein the degree of uniqueness of the fingerprint increases with the degree of complexity of the structure and composition of the fingerprint.

For example, for the purpose of generating a fingerprint having a high degree of uniqueness for each access request, process information 62 is determined from the access request 24 in a first stage 52, wherein this information indicates which process 22 triggered the access request 24, and in a second stage 54 unique identification criteria 64 in relation to the process 22 are determined.

Unique identification criteria 64 of this kind may be for example checksums regarding the requesting program and/or checksums regarding the DLLs of the requesting program and/or checksums regarding locations and/or addresses of the program starting the access request and/or time stamps of the last modifications of the program starting the access request, and in particular of the DLLs of this program starting the access request.

Both the process information 62 and the unique identification criteria 64 of the access request 24 are combined for example to make a fingerprint 66 that is associated with the access request 24.

In a third filter stage 48 the fingerprint 66 of the access request 24 is then compared with a whitelist 56 in which fingerprints 66S that are rated as safe are stored.

If the access request 24 is one for which the fingerprint 66 is labeled as a fingerprint 66S in the whitelist 56, then the third filter stage 48 forwards the access request 24 directly to the access layer 32, bypassing the file securing system 34.

If this is not the case, the access request 24 is forwarded to the file securing unit 34.

When the access request 24 is forwarded to the file securing unit 34, the access management system 26 uses a copying unit 72 to copy the fingerprint 66 into a gray list 74 of a process check 82 illustrated in FIG. 3, which, as illustrated in FIG. 3, makes the gray list 74 available to a check procedure 84, wherein the check procedure 84 either enters the fingerprints 66 that are in the gray list 74 in the whitelist 56, as a fingerprint 66S that is rated as safe, on the basis of the check procedure 84, or enters them in a blacklist 86 as an unsafe fingerprint 66U, or as an alternative to entry in the blacklist 86 stores them in another file or even discards them.

Here, the check procedure 84 may be performed with a time delay relative to the file access, for example by a system administrator who checks the fingerprint 66 manually, hours or days after the respective file access, and at this stage allocates it either to the whitelist 56 or the blacklist 86.

An automation of the check may thus already in this way request that if no malware has been identified within a predetermined time period, for example days or a week, the fingerprint 66 is allocated to the whitelist 56.

As an alternative, however, it is also possible to at least partly automate the check procedure 84 by a predetermined process sequence and thus for example to carry out the check procedure 84 partly automatically, by a program, and partly—for example if the program cannot determine a unique allocation—manually, for example by a system administrator.

In conjunction with the file securing unit 34 illustrated in FIG. 1, only the form taken by the file securing sequence 36 has been explained.

However, as illustrated in FIG. 4, it is preferable if the file securing unit 34 takes a form such that it associates the fingerprint 66 with the backup copy 18S of the file 18Z and/or associates it with the file 18Z that was accessed as a result of the access request 24.

Here, the fingerprint 66 is either stored in the file system 16, together with the respective files 18S or 18Z, or is stored in the file system 16 at another location and associated with the files 18S and/or 18Z by a suitable link.

In a second exemplary embodiment of an inventive data processing installation 10′, illustrated in FIG. 5, there is provided a server 102 that is connected to a multiplicity of clients 104, 106, 108 by way of a LAN system 112.

Each of the clients 104, 106, 108 includes a data processing device 12 that can generate a respective access request 24 in the context of a process 22.

In this case, there is no possibility for the data storage device 14 in the server 102 to determine, in addition to the process information 62, unique identification criteria 64 for determining the fingerprint 66 of an access request 24.

In the second exemplary embodiment of a data processing system 10′, illustrated in FIG. 5, a fingerprint determining unit 114 that is upstream of the server 102 is thus associated with each of the clients 104, 106, 108 and determines the respective fingerprint 66 for the respective access request 24, associates it with the access request 24 and transmits it with the access request 24 to the server 102, with the result that a packet comprising the access request 24 and the respective fingerprint 66 is transmitted to the server 102 over the LAN system, and the access request 24 together with the respective fingerprint 66 is then available in the server 102.

Otherwise, the data processing device 14 in the second exemplary embodiment operates in the same way as that described above in conjunction with the first exemplary embodiment.

In a third exemplary embodiment of a data processing system 10″ according to the invention, illustrated in FIG. 6, a server 102″ with clients 104″, 106″, 108″ is likewise provided, wherein an upstream fingerprint determining unit 114 is likewise provided in these clients 104″, 106″, 108″.

In this case, however, the determined fingerprint 66 is not associated directly with the access request 24 but is provided in each case with an identifier 122, which is identical to an identifier 122 likewise associated with the access request 24, and in this way the fingerprint 66 and the access request 24 are transmitted separately to the server 102″ over the LAN system 112.

The server 102″ associates the fingerprint 66 with the respective access request 24 again on the basis of the identical identifiers 122.

Otherwise, the data processing device 14 in the third exemplary embodiment operates in the same way as that described above in conjunction with the first exemplary embodiment.

In a second exemplary embodiment of an inventive data storage device 14, illustrated in FIG. 7, access to files in the file system 16′ by the access layer 32 is performed by means of a block position transformation stage 132, which must be used by the filter driver 32 in order to be able to recognize the files 18 in the file system 16′, whereas if the block position transformation stage 132 is not activated only irrelevant data in the file system 16′ is recognizable.

The block position transformation stage 132 has the effect on the storage medium of the data memory 20 of the file system 16′ that at least part of the respective file system header 134, which contains essential access information for the respective file system 16′, is stored not in the usual location on the storage medium but at another location determined by the block position transformation stage 132.

If the block position transformation stage 132 is used, it allows the file system 16′ to appear as a conventional file system 16 to the accessing system even though the file system header 134 is created at a different location.

For example, the file system header 134 required for the file system 16′, which is usually located at the block positions O to N-1, includes N blocks, and of these N blocks the block position transformation stage 132 stores for example the first N-X blocks of the file system header 134 in the block positions Y to Y+N-X, as the file system header part 134PT, while the remaining X blocks remain in their block positions.

If the file system 16 is now accessed using the block position transformation stage 132, then the block position transformation stage 132 mirrors the blocks in the block positions Y to Y+N-X—and thus the file system header part 134PT—in the blocks O to N-X, such that the file system 16′ appears to the access layer 32 as a file system 16 in which the file system header 134 is at the blocks O to N-1, with the result that all the files 18 are accessible.

If the block position transformation stage 132 is not used, the file system header 134 is not identifiable, and so none of the file 18 of the file system 16′ is locatable.

In order to avoid a situation in which, when the block position transformation stage 132 is not used, an access layer 32 is not configured to recognize the presence of a file system at all, the block position transformation stage 132 stores in the blocks O to N-X a substitute file system header 134′ that displays the existence of a file system of which the files have no relevant content, however, and when the block position transformation stage 132 is active the substitute file system header 134′ is not recognizable as such, but only the file system header 134 is recognized.

The block position transformation stage 132 has the advantage that if the access layer 32 is made non-operational, for example by malware or other damaging influences, the block position transformation stage 312 is no longer activated, and consequently the file system header 134 and hence also the entire file system on the storage medium is no longer locatable.

In a third exemplary embodiment of an inventive data storage device 14″, illustrated in FIG. 8, the file system 16″ having the files 18″ is encrypted, and in addition an encryption stage 142 is provided that must be activated by the access layer 32 in order to be able to recognize the encrypted files 18″ in the encrypted file system 16″.

All the solutions according to the invention provide the possibility, in the event of a file 18 of the file system 16 being made unusable by malware, in particular ransomware, for example being encrypted or destroyed, of using the fingerprint 66 that is associated with this unusable file 18 to search through the backup copies 18S or the files 18 for those that have the same fingerprint 66 and then to substitute in the file system 16 the unusable files 18 in the file system 16 by their backup copies 18S.

Before the substitution, moreover, in this case the process 22 in the data processing device 12 is eliminated as a process 22 that has been identified, on the basis of the fingerprint 66, as the process 22 that has led to unusable files 18 in the file system 16.

1.-17. (canceled)

18. A computer-implemented method for operating a data storage device, including an access management unit for a file system by which, in the event of an access request generated by a process in a data processing device and transmitted to the data storage device, for a file of the file system, this file is made available for file access, the access management unit includes a file securing unit by which, in the event of an access request for the file that is forwarded to this file securing unit, a file securing routine is started, in that the access request is blocked until a backup copy of the file has been created and stored, in that the access request is then forwarded to an access layer for the file system, and in that access is carried out by the access layer.

19. A method according to claim 18, wherein during the file securing routine, the backup copy of the file is stored in a protected data memory.

20. A method according to claim 18, wherein a fingerprint determining unit is provided, which, for the respective access request, determines a fingerprint that identifies the access request and forwards the access request together with the fingerprint.

21. A method according to claim 20, wherein the fingerprint determining unit determines the fingerprint on the basis of one or more items of information, such as process IDs and/or checksums and/or information on additional programs used in the process.

22. A method according to claim 21, wherein the fingerprint determining unit determines a fingerprint on the basis of the process information in the access request, and on the basis of a unique identification criterion determined in relation to the process.

23. A method according to claim 20, wherein the fingerprint determination is performed by the access management unit.

24. A method according to claim 20, wherein the fingerprint determination is performed in the data storage device of upstream clients that generate the respective access request.

25. A method according to claim 24, wherein the respective fingerprint is directly associated with the respective access request.

26. A method according to claim 24, wherein the respective fingerprint is associated with the access request by means of an identifier.

27. A method according to claim 18, wherein the access management unit includes at least one access filter, which checks an access request for at least one filter criterion and, in the event of this filter criterion being met, forwards the access request directly to the access layer, bypassing the file securing unit.

28. A method according to claim 27, wherein the access filter includes a first filter stage, which checks whether an access request relates to an existing file or a file to be newly generated, and which, in the case of a file to be newly generated, forwards the access request directly to the access layer, bypassing the file securing unit.

29. A method according to claim 27, wherein the access filter has a second filter stage, which checks whether an access request includes a write request or not, and which, in the event that there is no write request, forwards the access request directly to the access layer, bypassing the file securing unit.

30. A method according to claim 27, wherein the access filter has a third filter stage, which compares the fingerprint associated with the access request with a stored whitelist of fingerprints that are evaluated as safe, and which, in the event that the fingerprint of the access request is identical to a fingerprint in the whitelist, forwards the access request directly to the access layer, bypassing the file securing unit.

31. A method according to claim 18, wherein the access management unit extracts the fingerprint from the access request supplied to the file securing unit and stores it in a gray list of a process check.

32. A method according to claim 31, wherein the process check supplies the gray list to a check procedure, and in that the check procedure transfers the respective fingerprint in the gray list either to the whitelist of the third filter stage or to another location.

33. A method according to claim 32, wherein, during the check procedure, the process check transfers the respective fingerprint in the gray list either to the whitelist of the third filter stage or to a blacklist.

34. A method according to claim 32, wherein the check procedure is carried out by a user or automatically.

35. A method according to claim 18, wherein the file securing unit associates the fingerprint with the backup copy.

36. A method according to claim 18, wherein, when the backup copy is created, the file securing unit associates the fingerprint with the file that is accessed.

37. A method according to claim 18, wherein access to the file system by the access layer takes place by way of a block position transformation stage.

38. A method according to claim 18, wherein the file system is an encrypted file system, and in that access by the access layer takes place by way of an encryption stage.

39. A data processing system, including one or more processors that are configured to carry out the method according to claim 18.

40. A computer program product, including commands that, when the program is executed by a computer, cause it to carry out the method according to claim 18.

41. A computer-readable storage medium, including commands that, on execution by a computer, cause it to carry out the method according to claim 18.
